(19) United States
(12) Patent Application Publication
(10) Pub. No.: US 2009/0304942 A1
(43) Pub. Date: Dec. 10, 2009

(54) WIRE-ARC SPRAYING OF A ZINC-NICKEL COATING

(76) Inventors: Gary C. Erickson, Seattle, WA (US); Mark S. Pollack, Maple Valley, WA (US); Luong Tran, Tacoma, WA (US); Chris T. Zervas, Yarrow Point, WA (US); Paul D. Cacciola, Maple Valley, WA (US)

Correspondence Address: KLEIN, O'NEILL & SINGH, LLP, 43 CORPORATE PARK, SUITE 204, IRVINE, CA, 92606, US

(21) Appl. No.: 12/493,968

(22) Filed: Jun. 29, 2009

Related U.S. Application Data
(63) Continuation of application No. 11/006,415, filed on Dec. 7, 2004.

(51) Int. Cl. B05D 1/08

(52) U.S. Cl. 427/449

(57) ABSTRACT

A zinc-nickel substrate is applied to a component by using a zinc-nickel wire formed with between about 8 to 20 percent nickel and between about 80 to 90 percent zinc. This formed zinc-nickel wire is held in a two wire electric arc spray system to spray the zinc-nickel substrate on the component, such as an aircraft part, while operating the two wire electric arc spray system within a specific range of operating parameters.

### CROSS-REFERENCE TO RELATED APPLICATION

This application is a continuation of application Ser. No. 11/006,415, filed on Dec. 7, 2004, the entire contents of which are hereby incorporated by reference.

### TECHNICAL FIELD

This invention generally relates to thermal spraying and, more particularly, to an improved wire for and method of wire-arc spraying of zinc-nickel protective coatings on surfaces subject to corrosion and erosion.

### DESCRIPTION OF THE PRIOR ART

Currently various components of aircraft and wind and water power generating units, as well as components of other devices used in corrosive environments are coated with a protective coating by electroplating. For example, aircraft surfaces may be electroplated with cadmium or cadmium-titanium coatings. However, increased restrictions on processes that utilize hazardous materials, such as cyanide solutions, has led to increased prices for producing components employing such hazardous materials and a constantly reduced number of parties who wish to and/or have the capabilities to properly handle and dispose of such hazardous materials. Furthermore, when producing known components having a zinc-nickel coating thereon by electroplating, a post plate processing such as a hydrogen embrittlement bake must be performed, adding to the time to produce and cost thereof.

It has recently been found that wire-arc spraying of zinc-nickel protective coatings on aircraft components may be satisfactorily performed, without producing or using hazardous materials, if the correct mixture of zinc-nickel is use in the arc wires.

In known two wire electric arc spray systems (also known as twin-wire, arc spray or wire-arc spray), a direct-current (d.c.) electric arc is struck between two consumable electrodes (wires) resulting in the direct melting of the electrodes. Since the wires become molten due to the electric arc, the efficiencies of the process are considerably greater than those of other thermal spray processes. Atomizing gas, such as air or nitrogen, located behind the point where the two wires meet, is used to strip the continuously formed molten material from the melting wires that are fed at a fixed rate into the arc and melted. The velocity of the atomizing gas typically ranges from 30 to 90 SCFM. The physical effects associated with the atomizing gas are twofold; namely, 1) the production of finer molten particles and 2) the acceleration of the produced particles toward a substrate being coated.

As with any thermal process, heat is generated during a thermal spray process. In a two wire electric arc spray system the wire itself results in the least transfer of heat due to the fact that the only heat generated comes from the melting of the two wires in the electric arc. Whereas, the majority of other thermal spray processes utilize one or more fuel gases, such as hydrogen or propylene, as a part of the process to create similar molten materials. creating more heat. And, since the transfer of heat into the substrate being coated is a critical factor that affects the structural integrity of the component being coated, the heat transfer must be properly controlled. Therefore, with the two wire electric arc system, compressed air is blown on the component to maintain an acceptable temperature; while with other thermal spray processes carbon dioxide and compressed air cooling is required to maintain the temperature of the substrate within acceptable levels. This requirement to use additional cooling affects both flow time and the cost to coat components.

Additionally, material feed rates and deposit efficiencies of electric arc wire systems are typically higher than those of other thermal spray processes. In terms of the types of materials that can be sprayed through electric arc wire systems, the wires must be conductive materials that can be formed into wires; however, in some circumstances, cored wires having cermet materials as a filler core may also be used.

Since electric arc wire systems produce improved results with more controlled heating and without producing or using hazardous materials, there exists a need in the art for an improved wire for use with and an improved method for wire-arc spraying of zinc-nickel protective coatings on surfaces subject to corrosion and erosion.

### SUMMARY

It is, therefore, a general object of the present invention to provide an improved wire for use in a wire arc spray system. It is a particular object of the present invention to provide an improved method of electric arc spraying zinc-nickel wire on a substrate. It is a further particular object of the present invention to provide an improved zinc-nickel wire for use in a two wire electric arc spray system. It is yet another particular object of the present invention to provide an improved zinc-nickel wire for use in a two wire electric arc spray system having a composition of from about 8 to 20 percent nickel and about 80 to 92 percent zinc. It is a still further particular object of the present invention to provide an improved zinc-nickel wire for use in a two wire electric arc spray system utilizing between about 24 to 36 volts, about 80 to 200 amperes and an atomizing pressure of from about 80 to 120 psig. It is yet another particular object of the present invention to provide an improved method of electric arc spraying a zinc-nickel wire having from about 8 to 20 percent nickel and about 80 to 92 percent zinc onto a substrate. And, it is yet another particular object of the present invention to provide an improved method of electric arc spraying a zinc-nickel wire in a system utilizing between about 24 to 36 volts, about 80 to 200 amperes and an atomizing pressure of from about 80 to 120 psig.

These and other objects and advantages of the present invention are achieved by forming a zinc-nickel wire from between about 8 to 20 percent nickel and about 80 to 92 percent zinc. This formed wire is used in an improved method of spraying a zinc-nickel substrate on a component by means of a two wire electric arc spray system within a given range of machine parameters.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, in which:

FIG. 1 is a schematic view showing a cross-sectional view of an electrical twin wire arc system for use in a preferred method of the present invention; and

FIGS. 2a -2c are schematic cross-sectional views of various zinc-nickel wires of the present invention.

### DETAILED DESCRIPTION

The following description is provided to enable any person skilled in the art to make and use the invention and sets forth the best modes contemplated by the inventors of carrying out their invention. Various modifications, however, will remain readily apparent to those skilled in the art, since the generic principles of the present invention have been defined herein specifically to describe an improved zinc-nickel wire and a method of spraying a zinc-nickel coating onto a component, such as an aircraft part, by use of an electrical twin wire arc system operated at predetermined parameters, with the improved zinc-nickel wire.

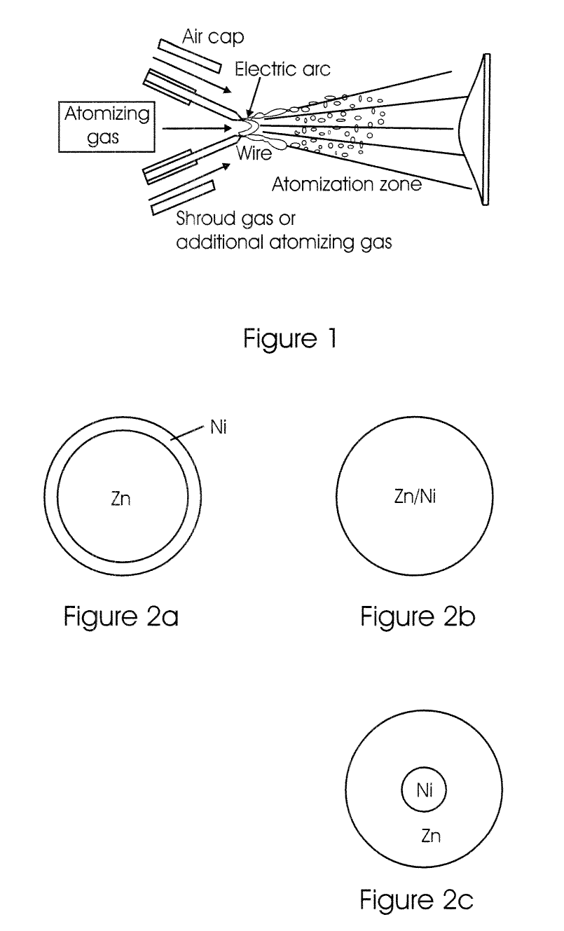

Turning now to the drawings, FIG. 1 shows a currently preferred embodiment of an electrical twin wire arc system or gun used to spray a zinc-nickel substrate onto a selected component, such as an aircraft part. The system or gun is of a known type, but is operated within specifically selected and controlled parameters for the unique zinc-nickel wire, described below, used therewith. In the preferred embodiments of the method of the invention, the voltage of the system or gun is maintained at about 24 to 36 volts, while the amperage is maintained at about 80 to 200 amperes and the pressure of the atomizing gas is maintained at about 80 to 120 psig. In a currently preferred embodiment of the method of the invention the system or gun is operated at about 30 volts and about 120 amperes, with the atomizing gas pressure about 100 psig.

In one aspect of the present invention, the zinc-nickel wire used in the two wire electric arc spray system is fabricated as shown in FIG. 2a by forming a zinc wire and electroplating a commercially available nickel plating to a thickness that achieves or defines a desired wire composition of from between about 8 to about 20 percent nickel and the balance being zinc from between about 80 to 92 percent. With the optimal concentration of nickel in the wire being between about 10 to 12 percent and the optimal concentration of zinc being between about 88 to 90 percent. In one currently preferred embodiment the wire, the concentration of nickel is about 10 percent and the concentration of zinc is about 90 percent.

In accordance with another aspect of the present invention, the zinc-nickel wire used in the two wire electric arc spray system is fabricated as shown in FIG. 2b by forming a zinc-nickel alloy melt that is then drawn to a final wire diameter in a known manner. Again, the preferred wire composition is from between about 8 to about 20 percent nickel with the balance being zinc from between about 80 to 90 percent. The optimal concentration of nickel in the wire is about 10 to 12 percent and the optimal concentration of zinc in the wire is about 88 to 90 percent.

In accordance with still another aspect of the present invention, the zinc-nickel wire used in the two wire electric arc spray system is fabricated as shown in FIG. 2c by forming a cored wire having a tubular zinc sheath with a finite amount of nickel powder in the core. The ends of the zinc sheath are sealed and the tube is drawn to the required wire diameter in a known manner. Again, the preferred wire composition is from between about 80 to 90 percent zinc in the sheath and between about 8 to about 20 percent powdered nickel in the core. The optimal concentration of powdered nickel in the core of the wire is about 10 to 12 percent and the optimal concentration of zinc in sheath of the wire is about 88 to 90 percent.

The preferred composition of the zinc-nickel wire for use as consumable electrodes in the two wire electric arc spray system or gun was arrived at by utilizing the following parameters: corrosion resistance, plating adhesion. paint adhesion, condensing humidity, torque tension test, filiform corrosion, microstructure analysis, coating compositions and residual stress.

Those skilled in the art will appreciate that various adaptations and modifications of the just-described preferred embodiments may be configured without departing from the scope and spirit of the invention. Therefore, it is to be understood that, within the scope of the appended claims, the invention may be practiced other than as specifically described herein.

What is claimed is:

1. A method of forming a zinc-nickel coating on a substrate to plate the substrate and protect the substrate from corrosion, the method comprising:
operating a thermal spray system;
feeding wire into the thermal spray system, the wire comprising at least one consumable electrode of the thermal spray system;
melting the at least one consumable electrode in the thermal spray system to form a molten zinc-nickel mixture; and
spraying the zinc-nickel mixture, using a source of pressurized atomizing gas, onto the substrate to form the zinc-nickel coating on the substrate,
wherein the wire includes an elongated zinc wire core with nickel surrounding the core to a thickness that results in the wire consisting of between about 8 and about 20 percent nickel and the balance zinc.

2. The method of claim 1, wherein the wire consists of between about 10 and about 12 percent nickel and the balance zinc.

3. The method of claim 1, wherein the wire consists of about 10 percent nickel and the balance zinc.

4. The method of claim 1, wherein the thermal spray system is a wire-arc spray system.

5. The method of claim 4, wherein the wire-arc spray system is a two wire electric arc spray system.

6. The method of claim 4, wherein the wire-arc spray system is operated at between about 24 volts and about 36 volts, between about 80 amperes and about 200 amperes, and with the source of pressurized atomizing gas at between about 80 psig and about 120 psig.

7. The method of claim 4, wherein the wire-arc spray system is operated at about 30 volts, about 120 amperes, and with the source of pressurized atomizing gas at about 100 psig.

8. A method of forming a zinc-nickel coating on a substrate to plate the substrate and protect the substrate from corrosion, the method comprising:
operating a thermal spray system;
feeding wire into the thermal spray system, the wire comprising at least one consumable electrode of the thermal spray system; melting the at least one consumable electrode in the thermal spray system to form a molten zinc-nickel mixture; and
spraying the zinc-nickel mixture, using a source of pressurized atomizing gas, onto the substrate to form the zinc-nickel coating on the substrate;
wherein the wire is a cored wire having a tubular zinc sheath with a nickel powder in the core and the wire consists of between about 8 and about 20 percent nickel and the balance zinc.

9. The method of claim 8, wherein the wire consists of between about 10 and about 12 percent nickel and the balance zinc.

10. The method of claim 8, wherein the wire consists of about 10 percent nickel and the balance zinc.

11. The method of claim 8, wherein the thermal spray system is a wire-arc spray system.

12. The method of claim 11, wherein the wire-arc spray system is a two wire electric arc spray system.

13. The method of claim 11, wherein the thermal spray system is operated at between about 24 volts and about 36 volts, between about 80 amperes and about 200 amperes, and with the source of pressurized atomizing gas at between about 80 psig and about 120 psig.

14. The method of claim 1, wherein the thermal spray system is operated at about 30 volts, about 120 amperes, and with the source of pressurized atomizing gas at about 100 psi.
